(19) United States
(12) Patent Application Publication
(10) Pub. No.: US 2013/0138614 A1
(43) Pub. Date: May 30, 2013

(54) TWO-PHASE DATA LOCKING TRANSACTION PROCESSING WITH DISTRIBUTED PARTITIONS AND MIRRORING

(71) Applicant: MARK TRAVIS, Santa Clara, CA (US)

(72) Inventor: MARK TRAVIS, Santa Clara, CA (US)

(21) Appl. No.: 13/308,148

(22) Filed: Nov. 30, 2011

(51) Int. Cl. G06F 17/30

(52) U.S. Cl. 707/658; 707/E17.007

(57) ABSTRACT

A data transaction processing system may include: an active node and a standby node, each having multiple data partitions managed by a data engine; a deadlock manager that determines whether a deadlock has occurred in connection with a requested data transaction; and a transaction agent for managing the transaction and communications with the data engines. The transaction agent in the active node may not commit a transaction until all portions of the transaction have been successfully completed in both the active and standby nodes.

### BACKGROUND

1. Technical Field

This disclosure relates to data transaction processing.

2. Description of Related Art

Data transaction processing may lock data records for the duration of the transaction; store data records persistently to disk; cache data elements that are most frequently used in system memory, in addition to on disk; maintain cache integrity by locking methods that operate slower than those described in the first step; and write committed transactions synchronously to a log on disk.

However, this approach may limit performance. Latency for each individual transaction may be limited by disk write latency. The locking required to manage cache integrity may not scale well as the number of CPU cores increase. A large amount of processing may be required to manage data between disk storage and the cache.

Architectures have been proposed to address these concerns.

One approach is known as VoItDB. Transactions are committed entirely within system memory and do not require synchronous disk I/O operations. Durability is acquired by synchronously copying data to redundant nodes. Data is partitioned across server nodes and, in some cases, within server nodes. Implementations may use a scheduling mechanism for transaction processing to ensure that all transactions begin and complete within all affected partitions without interleaving. Partitions may not maintain concurrent transactions. However, latency may be sacrificed for heavy throughput, and latency per individual transaction may be no better than with the approach first discussed above.

Another approach is known as NuoDB. Transaction processing is centered on multi-version concurrency control. However, scalability may require unique and ever increasing transaction identifier generation. This may be limited by processor speed and may degrade as processor cores that generate transaction ids increase. This may place a finite upper limit on system throughput.

### SUMMARY

A data transaction processing system may include an active node and a standby node. Both nodes may include multiple data partitions. Each partition may hold a partition of one or more records in a database. The records in the database of the active node may be replicated in the standby node.

Each active and standby node may include a data engine associated with each data partition. Each data engine may receive, perform, and report on requests to read and write designated records in its associated data partition and to lock the records during the process.

Each active and standby node may include a deadlock manager configured to determine whether a deadlock has occurred in connection with a requested data transaction concerning records in the database.

Each active and standby node may include a transaction agent. The transaction agent may receive the requested data transaction and, in response: identify the data engines that are associated with the data partitions that contain the records that are involved with the requested data transaction; issue a request to each identified data engine to read from or write to each of the involved records that are in the data partition associated with the data engine; and issue a request to each identified data engine to abort the requested reads and writes if the deadlock manager determines that a deadlock has occurred in connection with the requested data transaction.

The transaction agent that is part of the active node may issue a request to the transaction agent in the standby node to perform the same requested data transaction in connection with replica of the database.

The transaction agent that is part of the standby node, may, after all of its identified data engines have reported that the requested reads and writes have been completed, issue a request to each of its identified data engines to commit the requested reads and writes; and issue a response to the active node that it has completed its portion of the requested transaction.

The transaction agent that is part of the active node may, after all of its identified data engines have reported that the requested reads and writes have been completed and after receiving a response from the transaction agent in the standby node that it has completed the requested transaction: issue a request to each of its identified data engines to commit the requested reads and writes; and issue a response to the data transaction request indicating that the request has been performed.

Communications with the transaction agent, data engine, and the deadlock manager may utilize asynchronous messaging.

The data transaction processing system may include a connection handler configured to authenticate and parse each requested data transaction and to deliver the parsed version to the transaction agent.

The active node and the standby node may be in different physical machines.

Each data engine may include a cache that temporarily stores a request to read or write in connection with a data transaction request while the records that are the subject of the request are locked due to a different transaction request not yet being completed.

The transaction agent may ask the deadlock manager whether there is a deadlock when it receives reports from one or more of the data engines that are identified in response to a data transaction request that one of the involved records cannot be read or written to because of a different pending transaction request and another of the involved records may be read or written to because of the absence of a different pending transaction request.

The data transaction processing system may include a number of additional transaction agents in the active node and an equal number of additional transaction agents in the standby node, each of the type described above.

Each of the transaction agents in the active node may be paired with a different one of the transaction agents in the standby node. Still, there may be only a single deadlock manager in the active node and a single deadlock manager in the standby node. Each of the transaction agents may selectively communicate with all of the data engines in their node. A request dispatcher may be in the active node that causes each of the requested data transactions to be distributed to a selected one of the transaction agents in the active node based on its availability to handle the requested data transaction.

The data transaction processing system may include a number of additional active nodes and an equal number of additional standby nodes, each of the type described above. The deadlock manager within each active node may be a single deadlock manager shared by all of the active nodes. The deadlock manager within each standby node may be a single deadlock manager shared by all of the standby nodes. Each active node may be paired with a different one of the standby nodes. A request dispatcher may cause each of the requested data transactions to be distributed to a selected one of the active nodes based on its availability to handle the requested data transaction.

The data transaction processing system may include additional standby nodes, each of the type described above. The active node may selectively communicate with each of the standby nodes in the same way that the active node is described above as communicating with the standby node described above. Each of the additional standby nodes may selectively communicate with the active nodes in the same way that the standby node is described above as communicating with the active node.

The data transaction processing system may restart a requested data transaction after the deadlock manager determines that there is a deadlock.

After requesting any of the data engines to unlock any record as part of a response to the data transaction request, the transaction agent may not request any of the data engines to lock, read from, or write to a record as part of a response to the data transaction request.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a data transaction processing system in communication with a client.

FIG. 2 illustrates an example of a process that may be implemented by the data transaction processing system illustrated in FIG. 1.

FIG. 3 illustrates an example of components that may be in the active node illustrated in FIG. 1.

FIG. 4 illustrates an example of a process that may be implemented by the active node illustrated in FIG. 3.

FIG. 5 illustrates an example of components that may be in the standby node illustrated in FIG. 1.

FIG. 6 illustrates an example of a process that may be implemented by the standby node illustrated in FIG. 5.

FIG. 7 illustrates an example of an active node containing multiple transaction agents.

FIG. 8 illustrates an example of a standby node containing multiple transaction agents.

FIG. 9 illustrates an example of a transaction processing system containing multiple active nodes and multiple standby nodes.

FIG. 10 illustrates an example of a transaction processing system containing one active node and multiple standby nodes.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

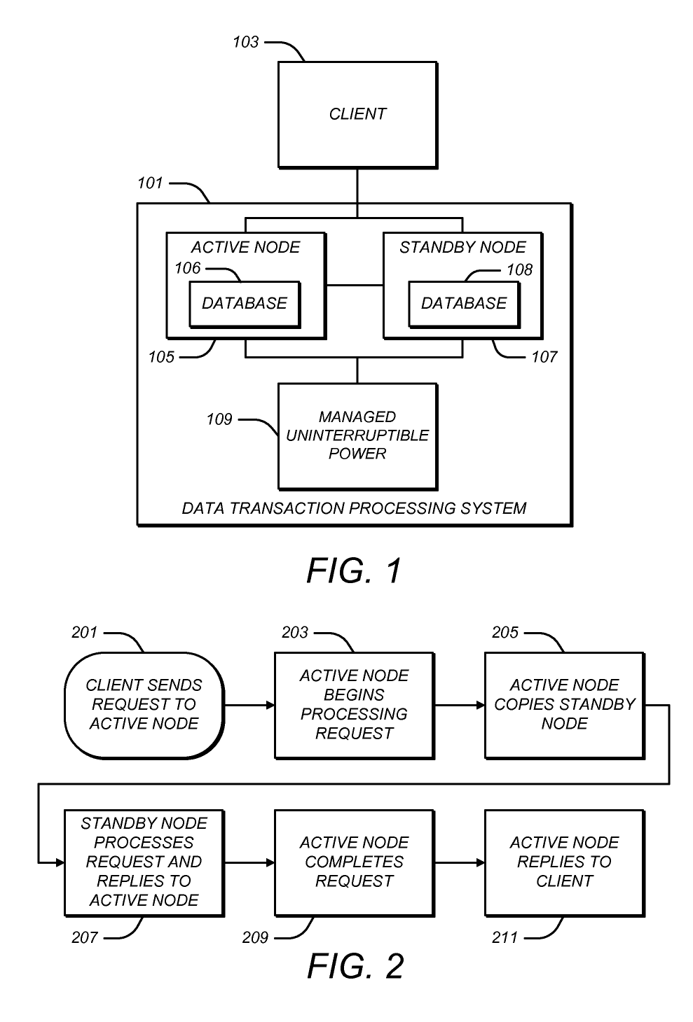

FIG. 1 illustrates an example of a data transaction processing system 101 in communication with a client 103. FIG. 2 illustrates an example of a process that may be implemented by the data transaction processing system 101 illustrated in FIG. 1. The process illustrated in FIG. 2 may be performed by a data transaction processing system that is different from the one illustrated in FIG. 1. Similarly, the data transaction processing system illustrated in FIG. 1 may perform a process that is different from the one illustrated in FIG. 2.

The client 103 may be of any type. For example, the client 103 may be a work station configured to send various data transaction requests to the data transaction processing system 101. The communications may take place over a network communication system, such as a local area network, a wide area network, the Internet, and/or a combination of these.

Although only a single client is illustrated in FIG. 1, there may be multiple clients that each send various data communication requests to the data transaction processing system 101. Each of these clients may be of the same or different type and may operate in the same or different way as the client 103 and may be part of a network communication system, such as a local area network, a wide area network, the Internet, or a combination of these.

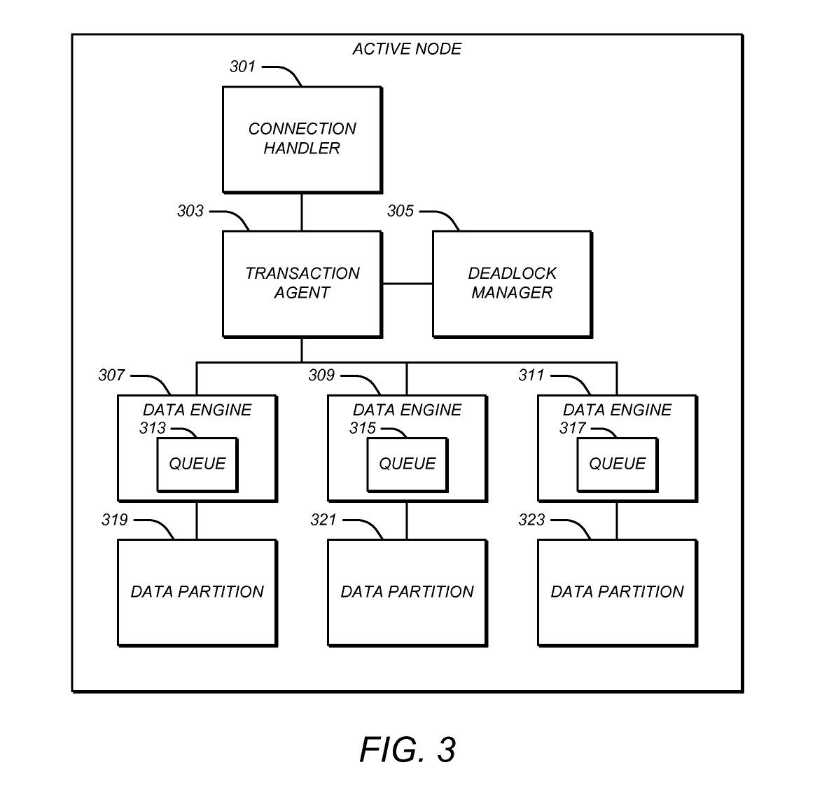

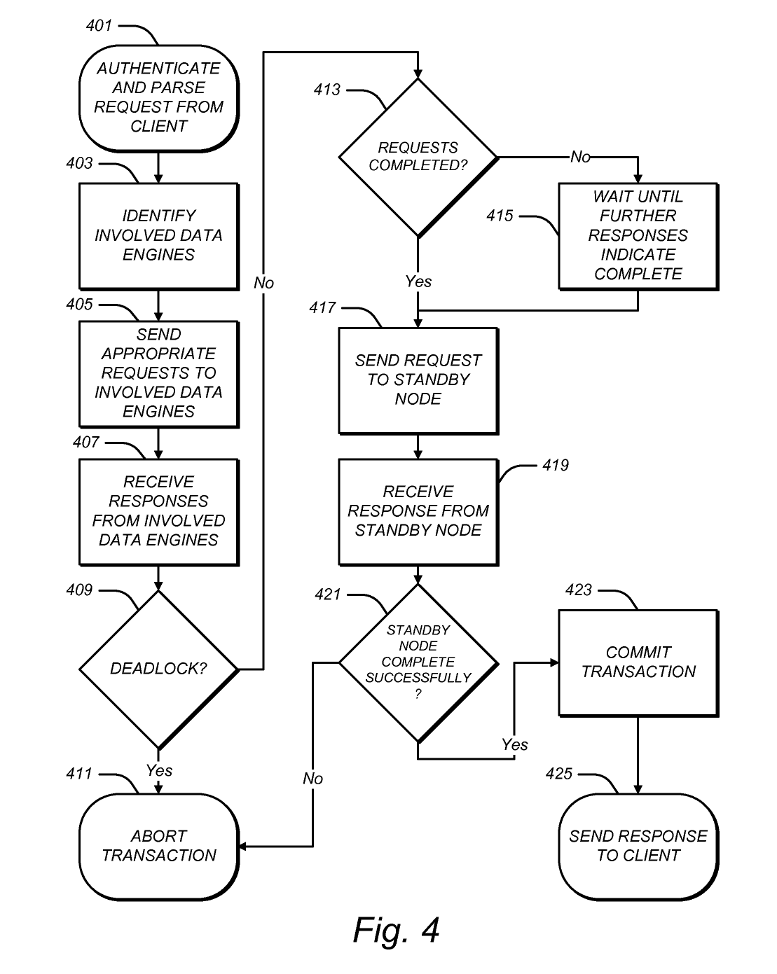

The client 103 may send a data transaction request to an active node 105 containing a database 106, as reflected by a Client Sends Request to Active Node step 201. Each data transaction request may require certain information to be read from or written to one or more records in a database 106 within the active node 105. Following receipt, the active node 105 may begin processing the request, as reflected by an Active Node Begins Processing Request step 203. An example of such processing is described below in connection with the discussion of FIGS. 3 and 4.

A standby node 107 may contain a database 108 that is a replica of the database 106. The active node 105 may send a copy of the data transaction request to the standby node 107, as reflected by an Active Node Copies Standby Node step 205. In response, the standby node 107 may perform the requested data transaction in connection with the database 108 and thereafter reply to the active node 105 advising that it has done so, as reflected by a Standby Node Processes Request and Replies to Active Node step 207. An example of how this may be done is described below. The active node 105 may then complete the data transaction request, as reflected by an Active Node Completes Request step 209, and then advise the client 103 that the data transaction request has been completed, as reflected by an Active Node Replies to Client step 211. During this step 211, the active node 105 may return any data that may have been requested as part of the data transaction request to the client 103.

In the event of a malfunction in the active node 105, the client 103 may be configured to instead send the data transaction request to the standby node 107 for processing. In an alternate configuration, the data transaction processing system 101 may include a routing module (not shown) that automatically detects the malfunction and thereafter automatically routes the incoming data transaction request to the standby node 107. In this case, the standby node 107 would process the incoming data transaction request in the same way as the active node would have, except that it may not send a replica of the request to any standby node or wait for a standby node to advise that it has been completed.

FIG. 3 illustrates an example of components that may be in the active node 105 illustrated in FIG. 1. FIG. 4 illustrates an example of a process that may be implemented by the active node 105 illustrated in FIG. 3. The process illustrated in FIG. 4 may be performed by an active node that is different from the one illustrated in FIG. 3. Similarly, the active node illustrated in FIG. 3 may perform a process that is different from the one illustrated in FIG. 4.

As illustrated in FIG. 3, the active node 105 may include a connection handler 301, a transaction agent 303, a deadlock manager 305, data engines 307, 309, and 311, containing, respectively, queues 313, 315, and 317, and data partitions 319, 321, and 323.

The data in the database 106 may be broken up into multiple partitions, such as into the data partitions 319, 321, and 323. Each data partition may be any type of data storage device, such as RAM or one or more hard disk drives. When stored in RAM, each partition may be a portion of system memory. Although only three data partitions are illustrated in FIG. three, the active node 105 may have a different number of data partitions, such as a larger number. As illustrated in FIG. 3, each data partition may have its own data engine associated with it and each data engine may have its own queue.

Upon receipt of a data transaction request, the connection handler 301 may be configured to authenticate the data transaction request and to parse and deliver it to the transaction agent 303, as reflected in an Authenticate and Parse Request from Client step 401. The parsing may modify the configuration of the data transaction request to conform it to a configuration required by the transaction agent 303.

The transaction agent 303 may then identify the data engines that are associated with the data partitions that contain the records that are involved with the requested data transaction, as reflected by an Identify Involve Data Engines step 403. The transaction agent 303 may perform this function by applying a hash function to the main field of the record and by calculating the remainder of the hash value divided by the total number of data engines. For example, if the hash function results in a decimal value of 1317, and there are a total of eight data engines, defined as instances 0 through 7, then the resulting data engines would be 5. The transaction agent 303 may also prepare a plan of sequential data requests to one or more of the identified data engines, as may be needed to perform the data transaction request.

The transaction agent 303 may then issue a request to each identified data engine to read from or write to each of the involved records that are in the data partition associated with that data engine, as reflected by a Send Appropriate Requests to Involve Data engines step 405. Each request may include a request to the data engine to first lock the records that are the subject of the request from access by other data transaction requests. In some cases, only a request to lock the involved records may be made at this stage of the processing.

The data engine receiving a request may check to see whether the involved records that it is managing are already locked pursuant to a request in connection with a different data transaction request. If not, the data engine may lock the identified records, perform any read or write to these records that is part of the request, and then send a response back to the transaction agent 303 indicating what has been done.

If one of the identified records is locked pursuant to a request in connection with a different data transaction request, on the other hand, the data engine may place the request to lock and read or write in its queue, and send a response back to the transaction agent 303 indicating that the request has been queued. When the data engine has completed processing all earlier requests concerning these identified records, some of which may also have been waiting ahead in line in the queue of the data engine, the data engine may then perform the transaction that was the subject of the queued request and then advise the transaction agent 303 indicating that the request has been completed.

After the transaction agent 303 receives an initial response from each of the identified data engines concerning all of the identified records, a determination may next be made as to whether there is a deadlock in connection with the data transaction request, as reflected by a Deadlock? decision step 409.

Any approach may be used to determine the existence of a deadlock. For example, the transaction agent 303 may determine whether the initial responses indicate that a request to lock in connection with one record has been queued while a request to lock in connection with another record has been performed. If so, this may indicate the possibility of a deadlock. The transaction agent 303 may be configured under such a mixed circumstance to send a request to the deadlock manager 305 to determine whether there is, in fact, a deadlock. The deadlock manager 305 may then determine whether there is, in fact, a deadlock and, if so, advise the transaction agent 303. The deadlock manager may do so, for example, by periodically constructing a wait-for graph based on the messages it receives from transaction agents. If a wait-for graph indicates a likely deadlock, then the deadlock manager may then choose one of the transactions causing the deadlock to abort and retry. It may then send a message to the transaction agent which controls the particular transaction chosen with a command to abort and retry the transaction. Put another way, if the wait-for graph indicates a deadlock, then there may generally be two notable transactions, either of which can be aborted, which would resolve the deadlock. In one implementation, the deadlock manager may gather messages from transaction agents in order to construct the graph. If it sees a deadlock, then it may choose one of the two transactions and sends a message to the target transaction's transaction agent that the transaction should be aborted and then retried. Aborting the transaction may unlock any records held by the transaction prior to any changes having been made by the transaction. A transaction aborted in this way may also no longer hold a pending lock on any records. This mechanism may resolve deadlocks.

If there is a deadlock, the transaction agent 303 may abort the transaction, as reflected by an abort transactions step 411. In such a situation, the transaction agent 303 may be configured to restart the transaction, i.e., to return to the Send Appropriate Request to Involve Data Engines step 405. In the event of repeated deadlocks, the transaction agent 303 may be configured to so advise the client that sent the data transaction request of the problem.

If there is no deadlock, on the other hand, the transaction agent 303 may determine whether all of the requests to the identified data engines have been completed, as reflected by a Request Complete? decision step 413. The answer might be no, for example, when one of the latest responses from one of the data engines indicate that a request has been queued. If the requests have not yet all been completed, the transaction agent 303 may wait until further responses indicate that they are all complete, as reflected by a Wait Until Further Responses Indicate Complete step 415.

The transaction agent 303 may send additional data transaction requests to one or more of the same data engines to comply with a single data transaction request from a client. This may occur, for example, in connection with data transaction requests that require a sequence of operations in connection with the same record or records, such as to read the record during a first step and to write to the record during a second step. In such a case, the Wait Until Further Responses Indicate Complete step 415 may wait until the transaction agent 303 is told that the last of the requests has been performed.

After the data transaction request has been fully performed in the data partitions of the active node, the transaction agent 303 may send a replica of the data transaction request to the standby node to again be performed in the standby node 107 in connection with its replica of the same database, as reflected by a Send Request to Standby Node step 417. The standby node 107 may then attempt to perform the data transaction request and to then advise the transaction agent 303 of its success.

The transaction agent 303 may then determine whether the response from the standby node 107 indicates that the data transaction request was successfully performed in the standby node 107, as reflected by a Standby Node Completes Successfully? decision step 421. If the response from the standby node 107 indicates that the data transaction request was not successfully performed in the standby node 107, the transaction agent 303 may abort the transaction, as reflected by the abort transaction step 411.

On the other hand, if the response from the standby node 107 indicates that the data transaction request was successfully performed in the standby node 107, the transaction agent 303 may commit the transaction and send a response through the connection handler 301 to the client 103 indicating that the data transaction request has been successfully performed, as indicated by a Commit Transaction step 423 and a Send Response to Client step 425, respectively. The transaction agent 303 may then commit the transaction, for example, by sending a request to each of the identified data engines to unlock the identified records.

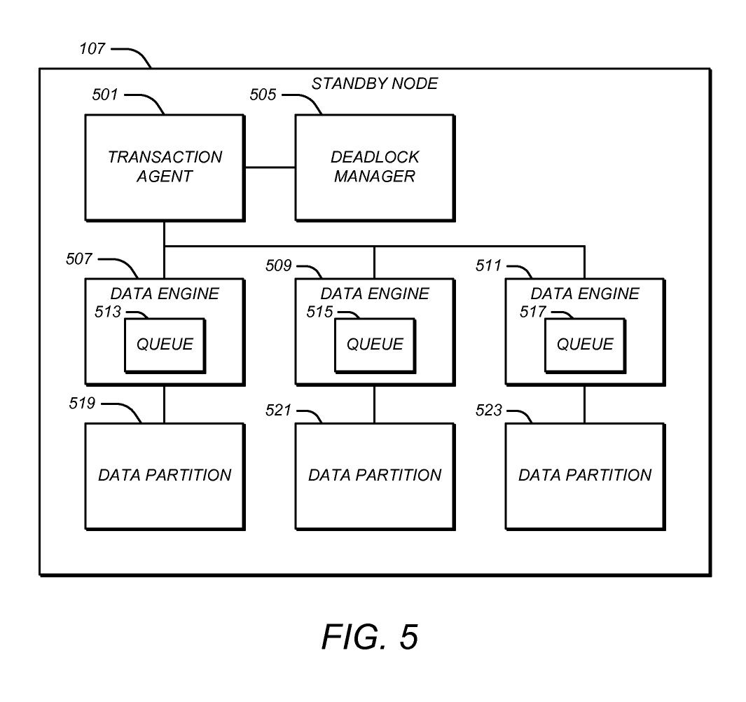

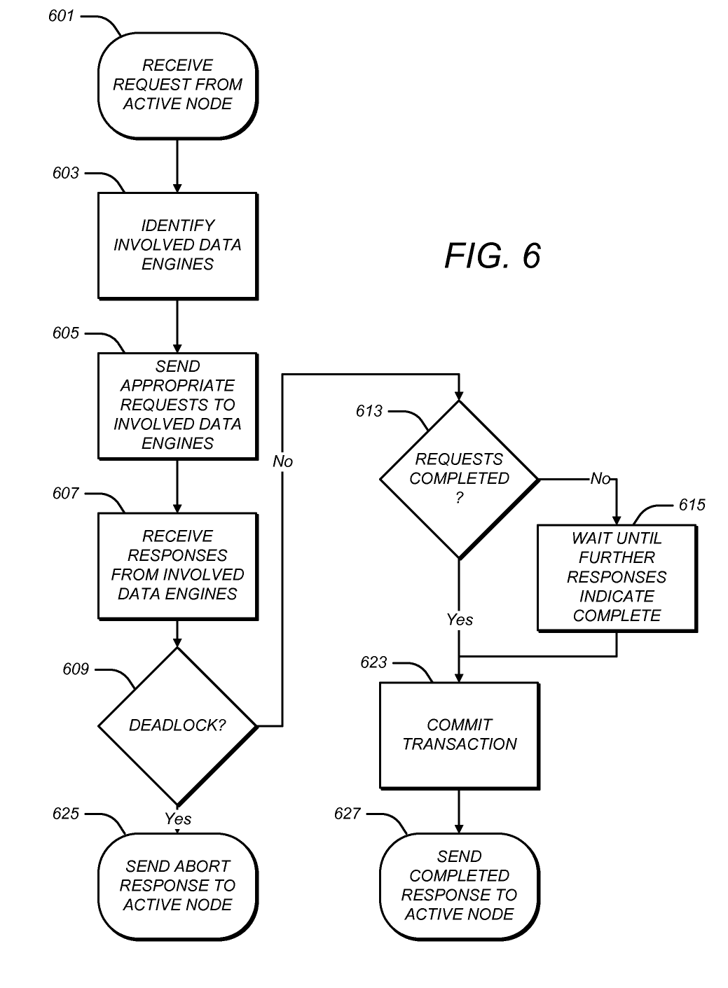

FIG. 5 illustrates an example of components that may be in the standby node 107 illustrated in FIG. 1. FIG. 6 illustrates an example of a process that may be implemented by the standby node 107 illustrated in FIG. 5. The process illustrated in FIG. 6 may be performed by a standby node that is different from the one illustrated in FIG. 5. Similarly, the standby node illustrated in FIG. 5 may perform a process that is different from the one illustrated in FIG. 6.

Except as now set forth, each of the components 501, 503, 505, 507, 509, 511, 513, 515, 517, 519, 521, and 523 that are illustrated in FIG. 5 and each of the steps 601, 603, 605, 607, 609, 611, 613, 615, 617, 619, 621, and 623 that are illustrated in FIG. 6 may be the same and subject to the same variations as the identically-named component and step illustrated in FIGS. 3 and 4, respectively.

One difference may be in connection with the transaction agent 501. Unlike the transaction agent 303, the transaction agent 501 may receive its data transaction request from the transaction agent 303, not from the connection handler 301. This is reflected by a Receive Request From Active Node step 601 and the absence of a connection handler in FIG. 5. Similarly, the transaction agent 501 may send a response indicating whether the requested data transaction was successfully performed, not to the client 103, but to the transaction agent 303. This is reflected by a Send Abort Response to Active Note step 625 and a Send Completed Response to Active Node step 605. In lieu of sending an abort response, the transaction agent 501 may wait and retry the transaction at a later time when there may be no deadlock. The transaction agent 501 may not send a copy of the data transaction request to any standby node or wait to receive a response relating to it from any standby node, as reflected by the absence of such steps from the FIG. 6.

The active node 105 and the standby node 107 may each be implemented with a computer system configured to perform the functions that have been described herein for them. Each computer system may include one or more processors, memory devices (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

The computer system that functions as the active node 105 may be physically separate from the computer system that functions as the standby node 107. Each node may be housed in a single physical container or in multiple containers. When in multiple physical containers, the various components of one node may communicate with one another through a network communication system, such as the Internet, a local area network, a wide area network, or a combination of these.

The data transaction processing system 101 may be scaled in various ways. Examples of these are now provided.

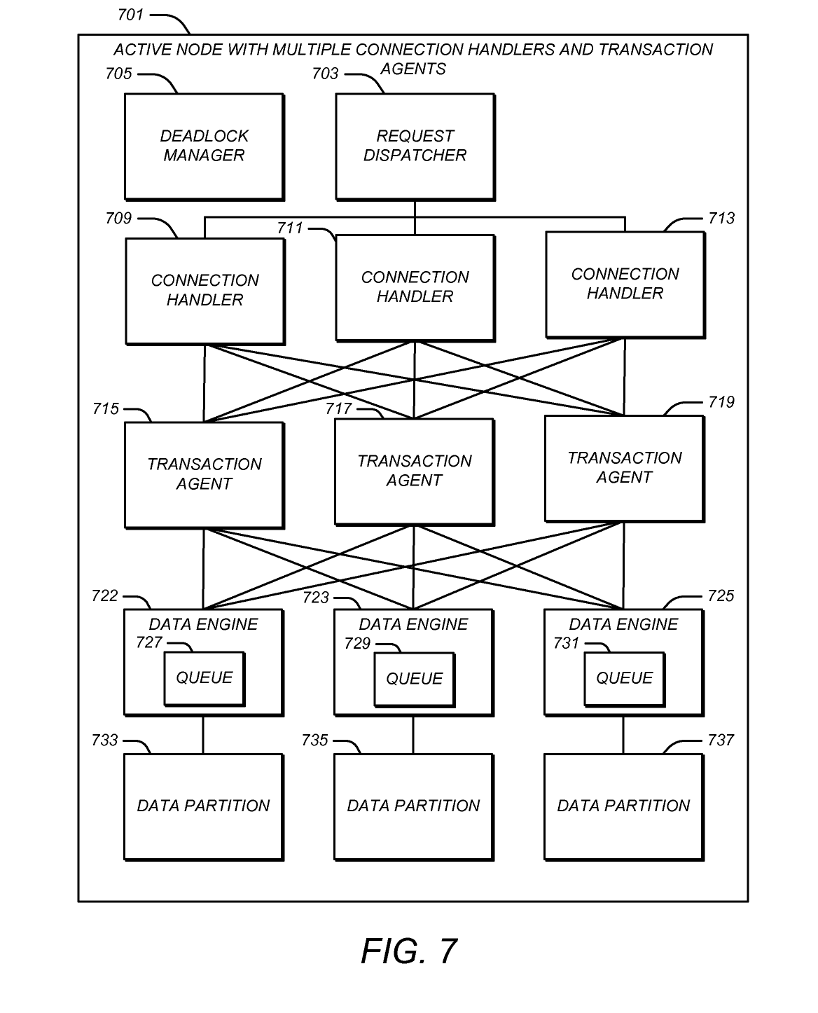

FIG. 7 illustrates an example of an active node 701 containing multiple transaction agents 715, 717, and 719. Except as now set forth, each of the components 705, 709, 711, 713, 715, 717, 719, 721, 723, 725, 727, 729, 731, 733, 735, and 737 that are illustrated in FIG. 7 may be the same, perform the same functions, and be subject to the same variations as the identically-named component illustrated in FIG. 3.

One difference may be that the active node 701 has multiple transaction agents 715, 717, and 717, and multiple connection handlers 709, 711, and 713.

A request dispatcher 703, such as a socket poller in certain configurations, may be configured to cause each of the requested data transactions from a client to be distributed to a selected one of the connection handlers based on the availability of the connection handler to handle the requested data transaction. Similarly, each connection handler may be configured to distribute each of the data transaction requests that it receives from the request dispatcher 703 to a selected one of the transaction agents based on the availability of the transaction agent to handle the requested data transaction.

The number of data engines/data partitions, transaction agents, and connection handlers are illustrated as being the same in FIG. 7. In different configurations, however, the number of data engines/data partitions, transaction agents, and connection handlers may be different.

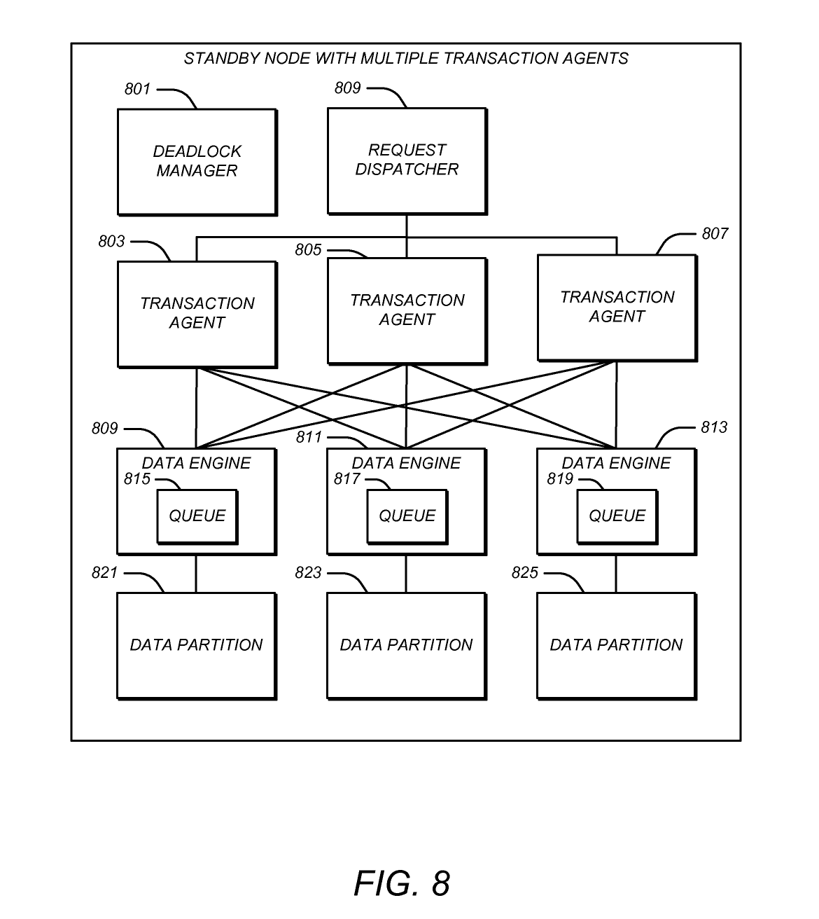

FIG. 8 illustrates an example of a standby node 801 containing multiple transaction agents 803, 805, and 807. Except as now set forth, each of the components 801, 803, 805, 807, 809, 811, 813, 815, 817, 819, 821, 823, and 825 that are illustrated in FIG. 8 may be the same, perform the same functions, and be subject to the same variations as the identically-named component illustrated in FIG. 5.

One difference may be that the standby node 801 may have multiple transaction agents 803, 805, and 807. As with FIG. 7, a request dispatcher 809 may be configured to cause each of the requested data transactions from a transaction agent in the active node to be distributed to a selected one of the transaction agents based on the availability of the transaction agent to handle the requested data transaction. In an alternate configuration, each transaction agent in the active node 701 may be assigned to a different one of the transaction agents in the standby node 801, thus eliminating the need for the request dispatcher 809. The multiple transaction agent standby node 801 may have any of the corresponding variations as discussed above in connection with the multiple transaction agent active node 701.

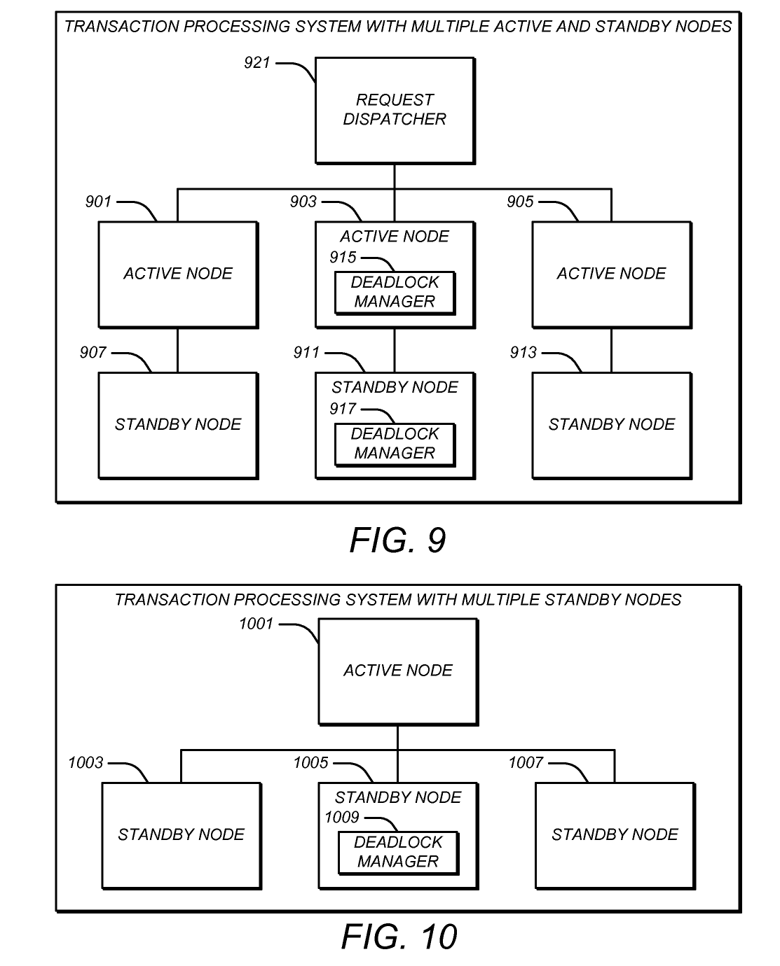

FIG. 9 illustrates an example of a transaction processing system containing multiple active nodes 901, 903, and 905, and multiple standby nodes 907, 911, and 913. Each of the components that are illustrated in FIG. 9 may be the same, perform the same functions, and be subject to the same variations as the identically-named component illustrated in FIGS. 1-8. A single request dispatcher 21 may be configured to distribute the data transaction requests from one or more clients to a selected one of the active nodes based on the availability of the active node to handle the data transaction request. Each active node, in turn, may be paired with one of the standby nodes, as also illustrated in FIG. 9, thus only utilizing its paired standby node for replication requests. In an alternate configuration, each active node may be configured to distribute its replication request to a selected one of the standby nodes based on the availability of the standby node to handle the replication request. As also illustrated in FIG. 9, a single deadlock manager 915 may be used by all of the active nodes and, similarly, a single deadlock manager 917 may be used by all of the standby nodes. The number of active and/or standby nodes may be different than what is illustrated.

FIG. 10 illustrates an example of a transaction processing system containing one active node 1001 and multiple standby nodes 1003, 1005, and 1007. Each of the components that are illustrated in FIG. 10 may be the same, perform the same functions, and be subject to the same variations as the identically-named component illustrated in FIGS. 1-8. In this configuration, a single active node 100 is configured to distribute each replication request to a selected one of the standby nodes based on the availability of the standby node to handle the replication request. Again, a single deadlock manager 109 may be shared among the standby nodes. The number of standby nodes may be different than what is illustrated.

A broad variety of refinements may be made. For example, redundant dedicated high speed interconnect fabrics may connect active nodes with standby nodes. However, such interconnect fabrics may not be used for communication with clients. Infiniband™ and 10 GB Ethernet™ are example technologies that may be used.

A disk may be made accessible to each node to store data in case of a shutdown, particularly when data partitions are in volatile memory. This may ensure that no data is lost.

A disk may be accessible to store data which overflows available data partition capacity.

Uninterruptible power supplies (UPS) and UPS management may be used. The system may implement redundant UPS systems and monitor their status to gracefully shut nodes down in case of a power outage.

A service availability manager may be used. It may monitor the health of each node and cause standby nodes to take the place of active nodes when a crash or other problem takes place.

A data manipulation interpreter, such as for Structured Query Language (SQL), Memcached protocol, or Advanced Message Queueing Protocol (AMQP), may be used.

Transaction rollback logic may used in a number of different circumstances, such as a when a needed record does not exist or its contents fail a check.

Each node may be identical. They may have the same type of CPU, such as a standard commodity server class, such as Intel Xeon or AMD Opteron, Oracle Sparc, IBM Power, or MIPS. Server class CPUs may tend to increase performance by way of increased core and thread count.

For solutions with data partitions residing in physical memory, a large memory capacity per system may be used. Memory redundancy and sparing technologies such as IBM Chipkill may be used.

For memory-based data partition systems, disk storage may only (“may only” here means “could only” and not “must”) be provided for booting the operating system, startup of the application, and for saving and restoring the data partitions.

Components may be redundant, such as network connections, power supplies, and cooling fans.

There may be at least one standby node for each active node. There may be multiple standby nodes for each active node. Each active node may have the same quantity of standby nodes. All nodes may have identical CPU and data partition storage sizes.

System availability management functionality may provide various features. It may monitor all hardware and software components. In the event of a node malfunction, it may cause a standby node to take the place of a failed active node, or causes a standby node to no longer be included in the transaction flow. It may notify human operators, such as through email, SNMP (Simple Network Management Protocol) or other methods, of system status changes. It may migrate network connections from failed to standby nodes.

The deadlock managers that have been described may be configured to resolve detected conflicts, rather than signaling the transaction agent to abandon a transaction.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

The communications with the various transaction agents, data engines, and the deadlock managers may utilize asynchronous messaging.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A data transaction processing system comprising:
an active node and a standby node, the active and the standby nodes comprising:
multiple data partitions, each configured to hold a partition of one or more records in a database, the records in the database of the active node being replicated in the standby node;
a data engine associated with each data partition, each data engine being configured to receive, perform, and report on requests to read and write designated records in its associated data partition and to lock and unlock the records during the process;
a deadlock manager configured to determine whether a deadlock has occurred in connection with a requested data transaction concerning records in the database; and
a transaction agent configured to receive the requested data transaction and, in response:
identify the data engines that are associated with the data partitions that contain the records that are involved with the requested data transaction;
issue a request to each identified data engine to read from or write to each of the involved records that are in the data partition associated with the data engine;
issue a request to each identified data engine to abort the requested reads and writes if the deadlock manager determines that a deadlock has occurred in connection with the requested data transaction;
for the transaction agent that is part of the active node, issue a request to the transaction agent in the standby node to perform the requested data transaction in connection with its database;
for the transaction agent that is part of the standby node, after all of its identified data engines have reported that the requested reads and writes have been completed:
issue a request to each of its identified data engines to commit the requested reads and writes; and
issue a response to the active node that it has completed its portion of the requested transaction;
for the transaction agent that is part of the active node, after all of its identified data engines have reported that the requested reads and writes have been completed and after receiving a response from the transaction agent in the standby node that it has completed the request transaction:
issue a request to each of its identified data engines to commit the requested reads and writes; and
issue a response to the data transaction request indicating that the request has been performed,
wherein communications with the transaction agent, data engine, and the deadlock manager utilize asynchronous messaging.

2. The data transaction processing system of claim 1 further comprising a connection handler configured to authenticate and parse each requested data transaction and to deliver the parsed version to the transaction agent.

3. The data transaction processing system of claim 1 wherein the active node and the standby node are in different physical machines.

4. The data transaction processing system of claim 1 wherein each data engine includes a queue configured to temporarily store a request to read or write in connection with a data transaction request while the records that are the subject of the request are locked due to a different transaction request not yet being completed.

5. The data transaction processing system of claim 1 wherein the transaction agent is configured to ask the deadlock manager whether there is a deadlock when it receives reports from one or more of the data engines that are identified in response to a data transaction request that one of the involved records cannot be read or written to because of a different pending transaction request and another of the involved records may be read or written to because of the absence of a different pending transaction request.

6. The data transaction processing system of claim 1 comprising a number of additional transaction agents in the active node and an equal number of additional transaction agents in the standby node, each of the type described in claim 1.

7. The data transaction processing system of claim 6 wherein each of the transaction agents in the active node are paired with a different one of the transaction agents in the standby node.

8. The data transaction processing system of claim 6 wherein there is only a single deadlock manager in the active node and a single deadlock manager in the standby node.

9. The data transaction processing system of claim 6 wherein each of the transaction agents is configured to selectively communicate with all of the data engines in their node.

10. The data transaction processing system of claim 6 further comprising a request dispatcher in the active node that is configured to cause each of the requested data transactions to be distributed to a selected one of the transaction agents in the active node based on its availability to handle the requested data transaction.

11. The data transaction processing system of claim 1 comprising a number of additional active nodes and an equal number of additional standby nodes, each of the type described in claim 1.

12. The data transaction processing system of claim 11 wherein the deadlock manager within each active node is a single deadlock manager shared by all of the active nodes.

13. The data transaction processing system of claim 11 wherein the deadlock manager within each standby node is a single deadlock manager shared by all of the standby nodes.

14. The data transaction processing system of claim 11 wherein each active node is paired with a different one of the standby nodes.

15. The data transaction processing system of claim 11 further comprising a request dispatcher configured to cause each of the requested data transactions to be distributed to a selected one of the active nodes based on its availability to handle the requested data transaction.

16. The data transaction processing system of claim 1 wherein the active node is configured to selectively communicate with each of the standby nodes in the same way that the active mode is described in claim 1 as communicating with the standby node described in claim 1.

17. The data transaction processing system of claim 16 wherein each of the additional standby nodes is configured to selectively communicate with the active nodes in the same way that the standby mode is described in claim 1 as communicating with the active node.

18. The data transaction processing system of claim 1 wherein the data transaction processing system is configured to restart a requested data transaction after the deadlock manager determines that it has caused a deadlock.

19. The data transaction processing system of claim 1 wherein the transaction agent is configured not to request any of the data engines to lock, read from, or write to a record as part of a response to a data transaction request, after requesting any of the data engines to unlock any record as part of a response to the data transaction request.

20. The data transaction processing system of claim 1 wherein each transaction agent is configured:
during a first phase to request each identified data engine to acquire a lock on the involved records before reading or writing to them and, once acquired, to then read or write to them; and
during a second phase that is initiated at such time as the commit request is issued, to release these locks as part of the commit request.
